(19) United States
(12) Patent Application Publication
(10) Pub. No.: US 2025/0124232 A1
(43) Pub. Date: Apr. 17, 2025

(54) SYSTEMS AND METHODS FOR APPLYING LARGE LANGUAGE MODELS TO PROPOSAL GENERATION FOR CONTRACTS

(71) Applicant: Kinvesting, LLC, Clio, MI (US)

(72) Inventor: Raymond Kusch, Clio, MI (US)

(21) Appl. No.: 18/986,666

(22) Filed: Dec. 18, 2024

Related U.S. Application Data
(63) Continuation-in-part of application No. 18/740,067, filed on Jun. 11, 2024, now abandoned.
(60) Provisional application No. 63/507,976, filed on Jun. 13, 2023.

(51) Int. Cl. G06F 40/30; G06F 40/205; G06Q 10/10

(52) U.S. Cl. CPC G06F 40/30; G06F 40/205; G06Q 10/10

(57) ABSTRACT

A computer-implemented method to train or guide a machine learning model to generate a contract proposal document may include receiving a request to generate a contract proposal, the request including a plurality of requirements and at least one of: an industry indication and a service indication; identifying, based on a first natural language model, a plurality of contract documents that satisfy at least one of the plurality of requirements; training, based on the first natural language model, the machine learning model to parse textual data in the identified plurality of contract documents; training, based on a second natural language model, the machine learning model to use the parsed textual data to generate input for the contract proposal document; and generating the contract proposal document using the generated input according to the training based on the first natural language model and the training based on the second natural learning model.

### CROSS-REFERENCE TO RELATED APPLICATION

This application is a continuation-in-part of U.S. Nonprovisional patent application Ser. No. 18/740,067, filed on Jun. 11, 2024, which claims the priority benefit of U.S. Provisional Application No. 63/507,976, filed on Jun. 13, 2023, the disclosure of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### SUMMARY

In some aspects, the techniques described herein relate to a computer-implemented method to train or guide a machine learning model to generate a contract proposal document, the method including: receiving a request to generate a contract proposal, the request including a plurality of requirements and at least one of: an industry indication and a service indication; identifying, based on a first natural language model, a plurality of contract documents that satisfy at least one of the plurality of requirements; training, based on the first natural language model, the machine learning model to parse textual data in the identified plurality of contract documents; training, based on a second natural language model, the machine learning model to use the parsed textual data to generate input for the contract proposal document, wherein the generated input includes text that mimics semantics of the textual data to adhere to the plurality of requirements; and generating the contract proposal document using the generated input according to the training based on the first natural language model and the training based on the second natural learning model.

In some aspects, the techniques described herein relate to a computer-implemented method for predicting a probability of winning contract work, the method including: obtaining information including a plurality of identifiers, a plurality of contract documents, a plurality of available contract work, and historical data about awarded contracts; determining a likelihood, based on the obtained information and for each of the plurality of identifiers, of winning the respective contract work according to the plurality of contract documents and the historical data about awarded contracts, the determining including; ranking the determined likelihoods of winning the respective contract work; generating, based on the ranking, at least one bid and a contract proposal document for contract work having a ranking above a predefined level.

In some aspects, the techniques described herein relate to a computer-implemented method of prioritizing contracts, the method including: training a first LLM model using existing contracts associated with a single or multiple companies; applying unsupervised learning to orient the first LLM toward government contracts; applying supervised learning from the previous contracts to tune the first LLM to increase predictive potential of the first LLM; tuning the first LLM to read and interpret government based contracts; adjusting one or more settings or parameters of the first LLM to increase a predictive capability of the first LLM; training a second LLM using available contracts associated with the single or multiple companies; applying unsupervised learning to orient the second LLM toward the government based contracts; applying supervised learning from the previous contracts to tune the second LLM to increase a predictive potential of the second LLM; tuning the second LLM to read and interpret the available contracts; adjusting one or more settings or parameters of the second LLM to increase a predictive capability of the second LLM; and applying reinforcement learning on the first LLM to cause the first LLM to output specific answers that mimic an expert proposal writer; and generating a new contract proposal document and inserting the specific answers into the contract proposal document.

### TECHNICAL FIELD

This disclosure relates generally to the field of applied Artificial Intelligence, and more specifically to the field of training and applying machine learning models, neural network models, deep learning models, or Natural Language Processing such as Large Language Models to contract and/or request for proposal prioritization and/or proposal drafting. Described herein are systems and methods for applying large language models to contract prioritization and proposal drafting.

### BACKGROUND

The U.S. Government contracting landscape has become increasingly challenging for businesses to navigate. The process is often complex and time-consuming, with lengthy proposal preparation and evaluation cycles. Moreover, the requirements and specifications of the various government agencies are frequently evolving, which makes it difficult for businesses to anticipate their specific needs and preferences. These issues create an environment with considerable barriers to entry and ultimately result in a significant drain on company resources. Furthermore, typical government financial constraints often mean that only the largest, most established firms are able to pursue opportunities successfully. Consequently, the playing field has proven to be tilted in favor of established government contractors, making it difficult for new businesses to participate, let alone compete, effectively.

The length of a Request for Proposal (RFP) or a Request for Quotation (RFQ) can vary widely based on the complexity and scope of the project. An RFP or RFQ might be just a few pages long for relatively simple projects. However, for complex, high-value projects, the RFP or RFQ could be hundreds of pages long. For example, it is not uncommon for an RFP or RFQ to be between 30 to 50 pages. Unfortunately, the SOW length is not necessarily indicative of its complexity. Even short RFPs or RFQs can be quite complex if they involve specialized work. Due to this, contractors must pay close attention to every detail in these documents, as they form the basis for the proposal and, ultimately, the contract itself. Finding and qualifying contracts and writing a competitive government contracting proposal can present several challenges.

Because of these challenges, many businesses opt to invest in specialized training, hire experienced consultants, or develop an in-house team dedicated to government contracts, if they continue to proceed at all. Furthermore, every day an additional—likely large but unknown—number of businesses are denied the ability to participate in this industry altogether because of the government's glass barriers to entry. Accordingly, there exists a need for new and improved systems and methods for contract, RFP, and/or RFQ prioritization and/or drafting.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a high-level embodiment of an example system that applies a first machine learning model, a first large language model (LLM), and a second LLM for contract prioritization and proposal drafting.

FIG. 2 illustrates a detailed embodiment of the example system for performing the methods described herein.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Systems and methods are described herein for automating the analysis and response to Requests for Proposals (RFPs) using a multi-agent (multi-large language model or multi-LLM) artificial intelligence (AI) architecture. The system implements multiple specialized AI agents that collaborate to analyze RFP requirements, assess technical feasibility, evaluate competitive positioning, and generate comprehensive proposal responses. The system may include a flexible human-in-the-loop architecture that allows for varying levels of automation and human oversight at key decision points. A memory system maintains context across agents while enabling both automated and manual operations. In some embodiments, the system integrates neural network-based prediction for bid/no-bid decisions with document analysis and generation capabilities.

As used herein, “contract,” RFP,” and “RFQ” may be used interchangeably.

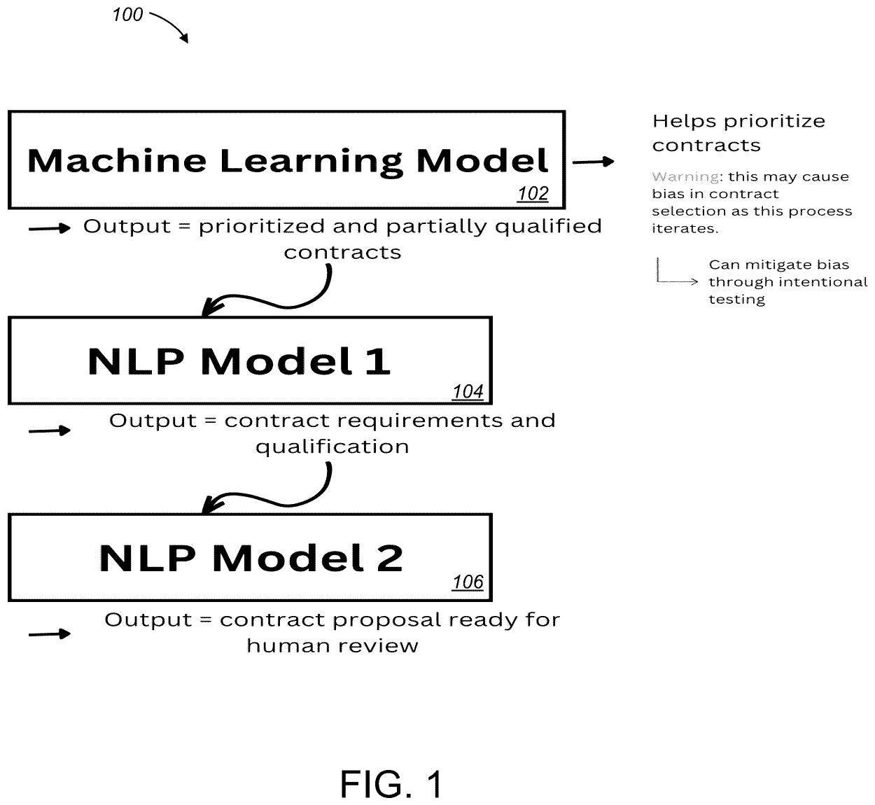

In some embodiments, for example as shown in FIG. 1, the system 200 may include a neural network-based contract analyzer 208 that processes RFP documents and predicts bid/no-bid recommendations. The system 200 may further include a contract generator 210, as shown in FIG. 1. The contract generator 210 may include a distributed multi-agent system with specialized AI agents for different aspects of proposal development. The system may include a memory 242 that maintains context and enables coordination between agents. In some embodiments, the system 200 may include a flexible human-in-the-loop architecture allowing variable automation levels. In some embodiments, system 200 may include integrated quality control mechanisms at one or more process points. In some embodiments, system 200 may include a nested, hierarchical decision-making structure that may at least partially mimic traditional proposal generation processes. The system 200 may reduce manual effort while improving proposal quality and win rates through consistent, data-driven processes. The system 200, or one or more components of the system, may be dynamically retrained to incorporate new data and/or outcomes and/or based on performance monitoring.

In some embodiments, the methods and systems described herein may be used for government contracting. In some embodiments, the methods and systems described herein may be used for helping veterans apply for medical and/or disability benefits. In some embodiments, the methods and systems described herein may be used to help a person apply to one or more government jobs (e.g., determine qualifications, write government resumes, etc.). In some embodiments, the methods and systems described herein may be used to help disabled and/or elderly people apply for social security benefits.

Conventional government contracting processes include contract selection (i.e., a large number of contracts exist at any given time; and employees of a company can select which contracts to pursue). Employees review the contract for proposal requirements and summarize contract requirements. Employees draft a proposal and other employees review the proposal, which is iteratively performed until a satisfactory proposal is finalized. The company submits the proposal with an unknown likelihood of success. The company receives the decision and may repeat the process.

To improve the above process, one or more AI models such as large language models (LLMs) may be trained and applied to enable contract, RFP, and/or RFQ prioritization (e.g., ranking) and/or proposal drafting. The contents of the drafts generated by the systems and methods described herein can include, but is not limited to, Statement of Work (SOW), project details, performance expectations, deliverables, administrative and contractual requirements, proposal preparation instructions, proposal creation, evaluation criteria, resource requirements, and the like.

In some embodiments, the systems and methods described herein may use LLMs to identify opportunities in which to submit a contract, RFP, RFQ, and/or proposal. Such opportunities may be identified by using one or more LLMs to parse contract opportunities on U.S. government websites such as SAM.gov, for example. Parsing websites to identify relevant contract opportunities using an LLM can include recognizing, translating, comparing, predicting, and/or summarizing opportunities in order to generate parsed data. The parsed data may be used by the LLM to generate text content including, but not limited to, RFPs, RFQs, and/or proposals.

The systems and methods described herein may also use LLMs to interpret requirements for a particular identified contract. Because government RFPs and RFQs are typically detailed and complex, the LLM may interpret and analyze the scope, terms, and conditions for use in generating a bid and/or proposal. Interpreting requirements for an identified contract may include using an LLM to parse the language of the requirements to compare and attempt to match company assets, resources, schedule, and/or requirements to the requirements of the identified contract. For example, company data may be stored in an external data source (e.g., company database or vector store), accessible by the LLM. The external data source may be passed through an extract, transform, and load (ETL) process to prepare the data for use by the LLM. In some embodiments, this may include qualifying (e.g., evaluating) the contract with respect to the capabilities, resources, and strategic goals of the company. The LLM may be trained via fine tuning and/or in-context learning to develop capabilities. The context provided to the LLM can be examples or data from an external data source such as a company database or vector store.

The systems and methods described herein may also use LLMs to develop and/or generate a competitive proposal based on the identified contract, prior company contracts, and/or other third party contracts. For example, the LLM may draft textual and/or graphical content for a proposal to ensure that the proposal meets (or exceeds) all the requirements of the identified contract. In some embodiments, two LLMs may be trained separately using model selection, fine tuning, and/or in-context learning to generate different capabilities per LLM. One LLM is trained and used to draft proposal content, the other LLM is trained and used to analyze the content of the proposal to determine whether it meets (or exceed) predefined requirements. In some embodiments, the LLM may obtain and use prior technical approaches performed by the company and/or prior performance of the company in other related contracts (e.g., based on fine tuning and/or in-context learning as described elsewhere herein). In some embodiments, the LLM may highlight particular team qualifications based on the prior technical approaches and/or prior performance of the company or the team member. The LLM may access a dataset that includes prior technical approaches and/or prior performance for the company or team member in order to highlight particular qualifications for the instant proposal. In some embodiments, the LLM may generate multiple bids for inclusion in a contract based on analysis of prior company-based contracts and/or contracts/proposals belonging to other third parties that may be unrelated to the company. For example, the LLM may learn an effectivity rate (e.g., by adjusting the weights of the fine tuning) for past contracts and/or for other third party contracts and use such learning as a basis for generating new competitive proposals.

The systems and methods described herein may also use LLMs to read and interpret proposals and/or contracts drafted by the LLM. The systems and methods described herein may also use LLMs to read and interpret proposals and/or contracts drafted by other users as a basis for generating new RFQs, RFPs, and/or proposals.

By way of example, data may be prepared through an ETL pipeline. During extraction, contract data may be gathered using APIs or user uploads. The transformation phase involves preprocessing, for example cleaning special characters, normalizing text formats, structuring unstructured data, and converting images into tensor representations suitable for model processing. The loading phase ensures all data is properly formatted and organized for model ingestion.

The preprocessed data may undergo tokenization, which converts the text into smaller units that one or more LLMs can process. Unlike simple syllable breaks, tokenization employs sophisticated algorithms like WordPiece or Byte-Pair Encoding to create a vocabulary of subword units. This process may be utilized for domain-specific documents to handle specialized vocabulary and maintain document structure. For example, the tokenizer might break “indemnification” into “in-demn-ification” based on frequency patterns in the training data, allowing the model to understand both common and rare legal terms efficiently.

These tokens are then transformed into embeddings—dense vector representations in a high-dimensional space. Each embedding captures not just the token's meaning, but also its position in the sequence and its relationships to other tokens. For instance, in contract analysis, these embeddings may encode semantic relationships between legal concepts, allowing the model to understand that “liability” and “responsibility” are related terms.

The embedded tokens are processed through a transformer architecture. This architecture employs multiple sophisticated mechanisms: self-attention layers that weigh the importance of different tokens in relation to each other, multi-head attention that processes these relationships from different perspectives, feed-forward neural networks that transform the representations, and both layer normalization and residual connections that help maintain stable training.

The generation process occurs through an iterative loop. The model predicts the probability distribution of the next token based on all previous tokens, weighted by attention mechanisms. This prediction is influenced by sampling parameters like temperature (controlling randomness) and top-k/top-p filtering (limiting the selection pool). The selected token is then fed back into the model along with the original sequence, and this process continues until a stop condition is met.

Organizations may choose to implement additional specialized training phases to enhance performance. The embedding model can be fine-tuned on domain-specific corpora to better represent domain-specific terminology. Similarly, the transformer architecture can undergo supervised learning using task-specific datasets, such as classified contracts with labeled outcomes. This process typically involves initial training over a broad domain-specific corpus, focused task-specific training, validation, and continuous refinement.

The process may be bounded by the LLM's context window which is the maximum number of tokens it can process at once. When processing lengthy documents that exceed the LLM's context window, various strategies can be employed. These might include document chunking along arbitrary section boundaries, natural section boundaries, sliding window processing with overlapping segments, hierarchical processing at multiple granularity levels, agentic chunking, which allows LLMs to choose where to chunk, and/or implementing external memory mechanisms to maintain contextual information.

The systems and methods described herein may also use LLMs to assess an ability of the company to deliver proper (and predefined) compliance with aspects of a particular identified contract. This may include ensuring that any generated proposals, for example, by the LLM account for and meet expectations for compliance to laws, regulations, and contract requirements. For example, the LLM may be trained to process a generated proposal and identify elements or parameters of the generated proposal that satisfy predefined laws, regulations, and/or contract requirements.

The systems and methods described herein may also use LLMs to assess resource constraints. For example and as described herein, one or more LLMs can review prior proposals generated by the company (and/or other proposals generated by third parties) to find, qualify, quantify, and/or bid on particular contracts without having to outlay human resources to do so. This can alleviate the need for hiring and managing a conventional multidisciplinary team that would be utilized to generate proposals, RFPs, RFQs, etc. When the LLM is trained and programmed to assess, learn, predict data in order to generate proposals, RFPs, RFQs, etc., a multidisciplinary team may not be utilized because the assessments and proposal generation may instead be generated by the LLM using trained data, past data, and/or user input.

One or more of the LLMs described herein may employ shared (consensus) context memory for cross-LLM coordination. One or more LLMs described herein may employ episodic memory for tracking decision points and state transitions. An LLM may be provided access to context for a particular role (e.g., budget generator 222, compliance detector 224, contractor generator 210, contract analyzer 208, requirement detector 216, ranking engine 226, etc.) after it has been generated, as described elsewhere herein.

As shown in FIG. 1, an improved process 100 may include: training a machine learning model 102 with data related to the contracts, company(ies), requirements, and/or historical proposals. The data may be enriched using feature engineering to generate and utilize any number of variables (e.g., time to first contract, return on investment, etc.). The process 100 may further include predicting the probability of winning a contract using the trained machine learning algorithm; and/or prioritizing a list of contracts based on the probability of winning the contract. The process 100 may utilize the trained machine learning model 102. The process 100 may optionally further include: receiving a selection of a contract to bid on. The selection may be based on the probability, such that a higher probability indicates a higher likelihood of successfully winning the bid for the contract. For example, probability may be determined by an ML algorithm generated using AutoML using the pycaret library of python. In some embodiments, receiving a selection may further include receiving an input including a managerial decision regarding a contract to bid on. In some embodiments, the process includes optimizing an expected return-on-investment (ROI) for one or more selected contracts. Said another way, the probability may additionally, or alternatively, be used to rank contracts by predicted return on investment (ROI). ROI of past contracts may be calculated and then utilized as one of the engineered features for a target variable during training. In some embodiments, the process 100 further includes receiving one or more decision inputs into the model as feedback into the model to improve model training, for example.

In some embodiments, one large language model (LLM) may be trained and/or applied to perform contract prioritization and/or proposal drafting. In some embodiments, one or more LLMs may be trained and/or applied to perform contract prioritization and/or proposal drafting. In some embodiments, two or more LLMs may be trained and/or applied to perform contract prioritization and/or proposal drafting.

For example, as shown in FIG. 1, a computer-implemented process 100 of generating contract proposal documents may include: training a first LLM 104 (e.g., that uses natural language processing (NLP)) using existing contracts associated with a single or multiple companies. The process 100 may further include applying unsupervised learning to orient a first LLM 104 toward the specific domain of government contracts. The process 100 may further include using supervised learning (e.g., using an annotated dataset and a randomized subset of that annotated data to use as a test for the trained model to rank against). from the previous contracts to fine-tune the first LLM 104 to increase predictive potential of the first LLM 104. The process 100 may further include tuning (e.g., using supervised learning as describe elsewhere herein) the first LLM to read and interpret government contracts. The process 100 may further include adjusting one or more settings or parameters (e.g., temperature, Top p, Top k, etc.) of the first LLM 104 to increase a predictive capability of the first LLM 104. In some embodiments, the process 100 may optionally include using reinforcement learning on the first LLM 104 to cause the first LLM 104 to output specific answers that mimic an expert proposal writer (or other position in the multidisciplinary team). In some embodiments, the first LLM 104 may be created or selected based on accuracy and/or legal ability to utilize the model. In some embodiments, a coding language, model type, one or more model parameters, one or more model features, etc. may be varied.

Further for example, as shown in FIG. 1, the process 100 may further include generating a proposal contract (document). For example, the process 100 may include: training a second LLM 106 (e.g., that uses natural language processing (NLP)) on existing contracts and/or proposals associated with a single or multiple companies. The process 100 may further include using unsupervised learning to orient the second LLM 106 toward the specific domain of government contracts and/or proposals. The process 100 may further include using reinforcement learning from the previous contracts and/or proposals to fine-tune the second LLM 106 to increase a predictive potential of the second LLM 106. The process 100 may further include tuning the second LLM 106 to read and interpret one or more contracts and/or proposals and adjusting one or more settings or parameters of the second LLM 106 to increase a predictive capability of the second LLM 106. For example, the LLM model may be identified as correct or incorrect, for example through a prompt, (or through direct preference optimization, what the user would have preferred the answer to be) and the LLM incorporates the correct or incorrect identifier into its training data for fine tuning. In some embodiments, the process 100 may optionally include using reinforcement learning on the second LLM 106 to increase a specific tone and/or answers that mimic an expert proposal writer or that mimic another selectable user type. For example, a direct preference prompt, indicating a specific tone or answer, may be fed into the LLM and the LLM may incorporate the prompt into its training data for fine tuning. This process may be iterated on to continually add data for further optimization.

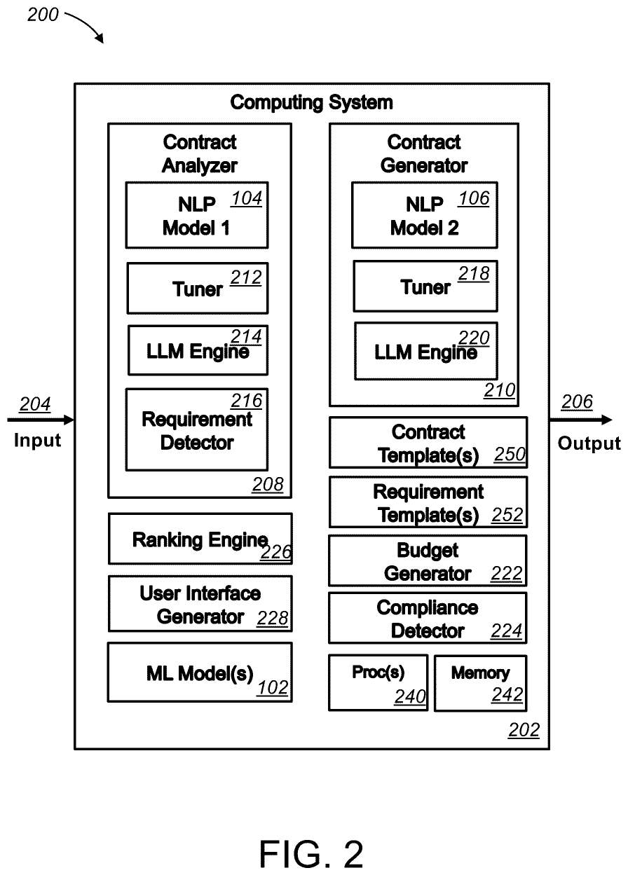

FIG. 2 illustrates a detailed embodiment of the example system 200 for performing the methods described herein. The system 200 includes at least one computing device or system 202. The computing device or system 202 may receive one or more inputs 204 to generate output 206, such as contract proposal documents, bids, likelihoods of winning particular contract work, etc.

The computing system 202 includes a contract analyzer 208 and a contract generator 210. The contract analyzer 208 may function to analyze information such as historical contract proposals, contract requirements, and/or other contract or bid related data for purposes of learning how such information can be used to generate new contract proposal (documents) and/or update other contract proposal (documents).

In some embodiments, one or more LLMs may be executed locally on a computing system (e.g., computing system 202), for example for confidential contracts and/or contracts that include security clearance specifications. The local computing system may, for example, be disconnected from the Internet. In some embodiments, one or more LLMs may be executed on a distributed network of computing systems. In some embodiments, one or more LLMs may be executed on a cloud computing system. In some embodiments, one or more LLMs may be executed through third-party software (generally accessed through, but not limited to, Application Program Interfaces (APIs)). The contract analyzer includes a first LLM 104 (e.g., an NLP model, a neural network), a tuner 212, and a first LLM engine 214 (e.g., a generative pre-trained transformer), and a requirement detector 216.

Tuner 212 may optimize or tune or adjust one or more hyperparameters (e.g., settings) of a machine learning model (e.g., LLM or NLP model 104) or LLM (e.g., one or more LLM in LLM engine 214) to improve its performance. Hyperparameters include but are not limited to learning rate, batch size, number of epochs, regularization parameters, decoding strategies, model architecture parameters, fine-tuning parameters, etc. Hyperparameters are further described elsewhere herein. Tuner 212 may additionally, or alternatively, adjusting one or more prompts or optimizing temperature or sampling adjustments.

The requirement detector 216 may receive an indicated, selected, and/or prioritized RFP and identify one or more RFP requirements and/or evaluation criteria. The requirement detector 216 may identify one or more government specifications (e.g., FAR, government set-aside codes, submission deadline, etc.), government standards, and/or expectations. The requirement detector 216 may output the RFP requirements, evaluation criteria, government specifications, etc. to the contract generator 210 for incorporation of the requirements into one or more draft proposals.

In some embodiments, the contract analyzer 208 may also determine a likelihood of a particular company winning a contract bid.

In some embodiments, the first LLM 104 may be used to read and interpret a plurality of contracts as input 204. In some embodiments, the first LLM 104 may be used to obtain contracts through a web search. In some embodiments, the first LLM 104 may be used to obtain contracts programmatically through automation (e.g., API, web scraping, etc.). In some embodiments, the first LLM 104 may be used to determine: which one or more contracts from the plurality of contracts the company qualifies for; and/or one or more requirements for developing a proposal. For example, the process may include using ETL, training a plurality of LLMs, and causing the plurality of LLMs to conduct different parts of the tasks described herein such as outlining the proposal, filling in the proposal, and verifying proposal facts.

The contract generator 210 may function to obtain contract text from the contract analyzer 208 and generate contract proposal documents using the contract text. In some embodiments, contract generator 210 may access a contract template 250. The contract template 250 may be based on a contract type, an entity type, an RFP subject matter, an RFP type, a government branch or department and the like. The contract template 250 may include a plurality of templates that are manually generated and accessible by the contract generator 210, or automatically generated by contract generator 210 and accessible by contract generator 210. In some embodiments, contract generator 210 may access a requirement template 252. The requirement template 252 may be based on a contract type, an entity type, an RFP subject matter, an RFP type, a government branch or department and the like. The contract template 250 may include a plurality of templates that are manually generated and accessible by the contract generator 210, or automatically generated by contract generator 210 and accessible by contract generator 210.

In some embodiments, the contract generator 210 may include a second LLM 106 (e.g., an NLP model, a neural network), a tuner 218, and a second LLM engine 220 (e.g., a generative pre-trained transformer). Tuner 218 may optimize or tune or adjust one or more hyperparameters (e.g., settings) of a machine learning model (e.g., LLM 106) or LLM (e.g., one or more LLM in LLM engine 220) to improve its performance. Hyperparameters include but are not limited to learning rate, batch size, number of epochs, regularization parameters, decoding strategies, model architecture parameters, fine-tuning parameters, etc. Hyperparameters are further described elsewhere herein. Tuner 218 may additionally, or alternatively, adjusting one or more prompts or optimizing temperature or sampling adjustments.

In some embodiments, contract generator 210 includes a plurality of agents (i.e., a plurality of LLM) as part of LLM engine 220. For example, LLM engine 220 may include a plurality of LLMs working in concert, sequentially, and/or in parallel to generator a draft proposal at output 206. By way of example, but in no way limiting, a first LLM of LLM engine 220 may be trained on technical data relevant to the identified or prioritized RFP. The first LLM, in response to one or more prompts defining one or more technical problems to be solved per the RFP, may output technical solutions to the one or more defined technical problems. The first LLM may further generate technical methodologies and/or technical specifications based on the technical problems and solutions.

By way of example, but in no way limiting, a second LLM of LLM engine 220 may receive draft iterations, partial drafts, portions of drafts, etc. and automatically update document formatting, style guidelines, etc. based on the identified or prioritized RFP and/or one or more other predefined requirements. The second LLM may modify a tone or style of the received draft, at least in some embodiments.

By way of example, but in no way limiting, a third LLM of LLM engine 220 may generate non-technical proposal content, for example executive summaries, management approaches, past performance sections, corporate capability content, etc. The third LLM may be trained on a database of internal documentation for the company leveraging system 200. The internal documentation may include summaries related to the company structure, management style, culture, performance metrics (e.g., gross profit margin, customer acquisition cost, cash flow, conversion rate, churn rate, customer retention rate, net promoter score, growth rate, average revenue per account, etc.) for historical context on past performance and predicting corporate capability, etc.

By way of example, but in no way limiting, a fourth LLM of LLM engine 220 may review draft iterations, partial drafts, portions of drafts, etc. based on one or more predefined quality metrics. The fourth LLM may compare the draft to one or more databases to verify content accuracy.

In some embodiments, using one or more contract requirements output 206 from the first LLM may be received as an input into the second LLM. In some embodiments, the second LLM may be used to generate a proposal. In some embodiments, a decision outcome may be input back into the first and/or the second LLM for additional model training.

The computing system 202 also includes one or more processors 240 (e.g., central processing unit, graphics processing unit, tensor processing unit, quantum processor, etc.) and memory 242 (e.g., video random access memory (VRAM), parametric memory, working memory, etc.). The one or more processors 240 may include one or more devices capable of executing instructions, such as instructions stored by the memory 242, to perform various tasks associated with operating the system 200. The memory 242 can include one or more non-transitory computer-readable storage media. The memory 242 may store instructions and data that are usable in combination with processors 240 to execute the processes/algorithms described herein, for example the machine learning models (e.g., model 104, model 106, LLM engines 214, 220, ML model 102, or the like). The memory 242 may also function to store or have access to the data associated with the contract analyzer 208, the contract generator 210, contract templates 250, requirement templates 252, budget generator 222, compliance detector 224, ranking engine 226, and/or user interface generator 228. Additional computing components may be included, but are not shown for brevity, including, but not limited to a power supply, a communication module, a display, additional processors, memory, external data storage (retrieval augmented generation such as semantic vector stores, knowledge graphs, etc.), etc.

The compliance detector 224 receives one or more drafted proposals from the contractor generator 210 and identifies whether the one or more drafted proposals meet (or are within a threshold) of one or more predefined requirements and/or regulations of an RFP for which the proposal was drafted. Compliance detector 224 may compare the one or more drafted proposals to one or more compliance databases, matrices, or lookups tables. The compliance database, matrix, or lookup table may define one or more checklists including compliance parameters. Compliance detector 224 may reference one or more compliance databases, matrices, or lookups tables in determining whether the one or more drafted proposals meet (or are within a threshold) of one or more predefined requirements or regulations of the RFP. The compliance detector 224 may output an indication of regulatory compliance. For example, the compliance detector 224 may output a score indicating a degree of regulatory compliance. The compliance detector 224 may output a probability of regulatory compliance. The compliance detector 224 may output a checklist indicating which parameters meet (or are within a threshold) of regulatory compliance and which parameters are failing to meet regulatory compliance. In some embodiments, compliance detector 224 optionally receives one or more drafted proposals and compares the one or more drafted proposals to a predefined list or database or solicitation requirements for the RFP for which the one or more proposals were drafted.

The ranking engine 226 receives one or more RFPs (e.g., at input 204) and segments them based on a competitive analysis and/or market analysis. The segmented RFPs may be ranked or prioritized based on the competitive and/or market analysis. For example, ranking engine 226 may receive one or more inputs related to a competitor or be trained on a database of competitor data. For example, the inputs or the competitor data may include, but not be limited to, competitor capabilities, competitive advantages, market positions, competitor insights, etc. Further for example, the ranking engine 226 may receive one or more inputs related to market trends or research or be trained on a database of market trends or research data. The inputs or the market trends or research data may include, but not be limited to, industry standards, market opportunities, market insights, customer needs, similar contracts, etc. One or more of the top ranked or prioritized RFPs may be analyzed by requirement detector 216 and/or fed into contract generator 210 for generation of a proposal. The ranking engine 226 may optionally further include filtering the one or more RFPs based on business objectives and/or adjusting filtering criteria based on business objectives. The ranking engine 226 may optionally further include adjusting a ranking or prioritization of RFPs based on a proposal volume versus win probability. The ranking engine 226 may optionally further include receiving a risk tolerance level or threshold for resource allocation and adjusting the ranking or prioritization based on the risk tolerance level or threshold.

The budget generator 222 receives one or more cost factors and generates cost estimates and/or executes a price analysis. The budget generator 222 of some embodiments generates pricing strategies and/or validates pricing assumptions (e.g., based on input pricing assumptions, pricing assumptions known in the industry, etc.).

User interface generator 228 may provide or generate one or more user interfaces for interaction of the system 200 with a user, for example human in the loop interaction. The user interface generator 228 may generate one or more text input fields to prompt portions of system 200, for example LLM 214, LLM engine 220, etc. The user interface generator 228 may generate a proposal output interface for review, editing, etc. of the proposal by a user.

In some embodiments, any of the models described herein may use natural language processing. Natural language processing (NLP) is a subfield of artificial intelligence and computer science that focuses on the tokenization of data—the parsing of human language into its elemental pieces. By combining computational linguistics with statistical machine learning techniques and deep learning models, NLP enables computers to process human language in the form of text or voice data. Lemmatization and part of speech tagging enable a deep understanding of language, including context, the intent, and/or sentiment of a speaker or writer. Statistical NLP combines computer algorithms with machine learning and deep learning models to automatically extract, classify, and label elements of text and voice data and then assign a statistical likelihood to each possible meaning of those elements. Deep learning models and learning techniques based on convolutional neural networks (CNNs) and recurrent neural networks (RNNs) enable NLP systems that ‘learn’ as they work and extract ever more accurate meaning from huge volumes of raw, unstructured, and unlabeled text and voice data sets.

As used herein, “unsupervised learning” may include a first step in training a language model. The model is fed a large amount of text data and asked to predict the next word in a sentence, given all the previous words. The model isn't given any explicit labels or targets apart from the text itself. For example, in the context of RFP analysis and response generation, unsupervised learning may be implemented by training the model on a large corpus of historical government RFPs and their corresponding successful proposals. The model processes this dataset by analyzing sequences of text within RFP sections and their matching proposal responses. Given an RFP section stating “Contractor shall provide cybersecurity monitoring services for cloud-based applications,” the model learns to predict the subsequent technical requirements and appropriate response patterns without explicit labeling.

Through this process, the model develops the ability to recognize standard RFP structures, technical requirement patterns, and effective response formats. When encountering the phrase “minimum security clearance requirements,” for example, the model learns to anticipate associated personnel qualifications, facility requirements, and compliance standards that typically follow in government RFPs. Similarly, when processing successful proposal responses, the model learns to predict appropriate technical narrative structures, such as following a “challenge-approach-benefit” pattern when responding to technical requirements.

The model also develops the capability to identify and predict domain-specific terminology and compliance language. For instance, when processing text containing “NIST 800-53 controls,” the model learns to anticipate and generate appropriate references to specific security control families, implementation details, and assessment procedures without being explicitly trained on security control frameworks. This unsupervised learning enables the model to generate contextually appropriate proposal content that maintains consistency with federal cybersecurity standards and requirements.

An unsupervised pre-training phase establishes fundamental patterns in proposal development before any supervised fine-tuning occurs. The model learns to recognize and generate appropriate response structures, technical terminology, and compliance language through pattern recognition rather than explicit rules or labels. This foundation enables subsequent supervised learning phases to focus on refining specific aspects of proposal generation rather than teaching basic proposal structures and terminology.

As used herein, “supervised learning” may include fine-tuning a model on a specific task using supervised learning. For example, in the context of RFP analysis and response generation, supervised learning may be implemented using a dataset of historical proposals paired with their outcomes and evaluation scores. The training data includes explicit labels such as “win” or “loss” for overall proposal outcomes, as well as numerical scores (e.g., 0-100) for specific evaluation criteria like technical approach, past performance, and cost realism. For instance, a proposal section responding to technical requirements may be labeled with both the agency's technical evaluation score and specific strengths or weaknesses identified during source selection.

The model can be trained on pairs of RFP requirements and their corresponding proposal responses, where each response is labeled with its evaluation outcome. For example, an RFP requirement stating “Describe your approach to implementing zero-trust architecture” might be paired with multiple proposal responses, each labeled with scores and specific feedback: a response receiving a score of 95 and labeled as “exceptional” might detail a comprehensive implementation strategy with specific tools and timeline, while a response scored at 65 and labeled as “marginal” might lack implementation specifics or risk mitigation strategies.

Through this supervised learning process, the model develops the ability to distinguish between high-scoring and low-scoring response patterns. When the model encounters a technical requirement asking for “detailed staffing approach,” it learns that responses labeled as “outstanding” typically include specific labor categories, qualification requirements, recruitment strategies, and retention plans, while responses labeled as “unacceptable” often lack these elements or provide only generic statements. This labeled training enables the model to learn specific patterns that correlate with proposal success or failure. For instance, the model learns that proposal sections labeled as “significant strength” often include quantifiable past performance metrics, specific technical approaches validated through previous contracts, and clear mapping between requirements and proposed solutions. Conversely, sections labeled as “significant weakness” typically exhibit gaps in addressing requirements, lack supporting evidence, or fail to provide required details.

As used herein, “reinforcement learning” includes training a model to make a series of decisions that lead to an end goal, with the model receiving feedback in the form of rewards or punishments. For example, in the context of RFP response generation, reinforcement learning may be implemented through iterative feedback from expert proposal writers who evaluate and refine the model's outputs. In this process, experienced proposal managers and subject matter experts review generated proposal sections and provide structured feedback that serves as a reward signal to optimize the model's performance. For instance, when responding to a technical requirement for “secure cloud migration methodology,” the model generates multiple response variations. Expert reviewers then rate these responses across multiple dimensions such as technical accuracy, compliance completeness, and competitive positioning.

The reinforcement learning process may be particularly illustrated in the development of past performance citations. The model generates descriptions of relevant contract experience, and proposal experts provide feedback on elements such as the strength of relevancy justification, level of quantifiable results included, and effectiveness of challenge-resolution narratives. A response receiving high ratings might effectively connect previous cloud migration projects to specific RFP requirements while quantifying cost savings and risk reduction. Conversely, a response receiving low ratings might focus on superficial project descriptions without establishing clear relevance or measurable outcomes.

The reward mechanism may be further refined through a specialized evaluation framework where proposal experts, acting as trainers, demonstrate both successful and unsuccessful response patterns. These trainers interact with the model in a manner similar to actual proposal development, presenting RFP requirements and iteratively refining generated responses. The trainers have access to a proposal evaluation rubric that aligns with federal source selection criteria, enabling them to provide consistent feedback that reinforces desired response characteristics.

Through this process, the model learns to optimize its responses based on expert feedback patterns. For example, when addressing staffing requirements, the model learns that responses receive higher rewards when they include specific details about key personnel qualifications, clear organizational structures, and defined succession planning, while receiving lower rewards for generic staffing descriptions or undefined roles. This creates a reward model that progressively refines the system's ability to generate proposal content that aligns with federal evaluation criteria and proven win strategies.

Each of these methods has its strengths and is suited to different tasks. Unsupervised learning can leverage large amounts of unlabeled data, supervised learning can fine-tune the model for specific tasks with high precision, and reinforcement learning can optimize for complex, multi-step tasks where the best action depends on the context.

In some embodiments, tuning a machine learning model, also known as hyperparameter optimization or hyperparameter tuning, is the process of adjusting the settings of a machine learning model to improve its performance. This involves changing the values of the model's hyperparameters, which are parameters that aren't learned from the data during training but are set before the training process begins. For an RFP analysis and proposal generation system, several key hyperparameters may be tuned to optimize performance:

Temperature Setting (Response Generation). The temperature parameter controls how “creative” or deterministic the model's outputs are. In proposal writing, this is particularly important because different sections require different levels of creativity. For technical requirement responses, a lower temperature (around 0.3-0.4) may be used to ensure consistent, precise outputs that strictly adhere to federal requirements. However, for executive summaries or past performance narratives, a slightly higher temperature (0.6-0.7) may be used to help generate more engaging content while still maintaining professional standards.

Context Window Size (Document Processing). Government RFPs can be lengthy, often exceeding 100 pages. The context window size determines how much of the RFP the model can process at once. While larger windows (16K-32K tokens) enable more comprehensive analysis of requirements and their interrelationships, they also increase computational costs. The optimal setting often depends on the typical structure of your target RFPs—for example, technical requirements sections might need larger windows than past performance sections.

Batch Size (Training Process). In training the model on historical proposals, batch size impacts how well the model learns proposal patterns. Larger batch sizes (16-32 proposals) can help the model better recognize common patterns across different types of government contracts. However, if your training data includes highly specialized or classified contracts, smaller batch sizes (4-8) might help preserve the unique characteristics of each proposal type.

Learning Rate Schedule. The learning rate for proposal generation requires tuning because different aspects of proposal writing have different complexity levels. You might use a warm-up period with a lower learning rate (1e−5) when training on basic proposal structures, then increase it (to 2e−5 or 3e−5) for learning complex technical response patterns, and reduce it again (to 5e−6) for fine-tuning on client-specific proposal styles.

Top-k and Top-p Sampling. These parameters control how the model selects words when generating proposal content. For technical sections where accuracy is paramount, you might set a lower top-p value (0.85) to ensure the model stays within acceptable technical terminology. For more narrative sections, a higher value (0.92) allows for more natural language flow while still maintaining professional standards.

Gradient Accumulation Steps. This parameter may be used when training on longer proposal documents. Since government proposals often exceed normal training sequence lengths, you might set gradient accumulation steps higher (8-16 steps) to effectively learn from longer documents while managing memory constraints.

The reason these specific parameters may be used:

Compliance: Government contracts require extremely precise language and strict adherence to requirements.

Document Length: RFPs and proposals are much longer than typical training texts.

Domain Specificity: Technical terminology must be used accurately and consistently.

Quality Standards: Generated content must meet federal evaluation criteria.

For example, if you're training the model to generate technical approaches for Department of Defense cybersecurity contracts, you might configure:

‘‘‘python
training_config = {
′temperature′: 0.35, # High precision for technical requirements
′context_length′: 24576, # Large window for comprehensive requirement
analysis
′batch_size′: 8, # Small batches for specialized contracts
′learning_rate′: 2e−5, # Balanced for technical content
′top_p′: 0.88, # Controlled variation while maintaining accuracy
′grad_accum_steps′: 12 # Handles long proposal document
}‘‘‘

These settings may help ensure the model generates precise technical content while maintaining the specific formatting and compliance requirements of defense contracts.

Hyperparameters can include (but are not limited to) factors like:

Learning Rate: It determines the step size that is taken to reach the minimum of the loss function during training. If the learning rate is too high, the model may overshoot the minimum, and if it's too low, the model may take too long to converge or may get stuck in a local minimum.

Batch Size: This is the number of training examples used in one iteration. Larger batch sizes can lead to faster training, but they also require more memory and may lead to less accurate models.

Number of Epochs: This is the number of times the learning algorithm will work through the entire training dataset. More epochs can lead to a more accurate model, but also can lead to overfitting if the number is too high.

Regularization Parameters: Regularization is a technique used to prevent overfitting by adding a penalty term to the loss function. The strength of the penalty is controlled by a hyperparameter.

When tuning Large Language Models like GPT-3 or Falcon, examples could include:

Decoding strategies: Parameters like temperature (which controls the randomness of the model's output) and top-k or top-p sampling (which limit the model's choices to a subset of the most likely next tokens) can be tuned to balance diversity and coherence in the model's responses.

Model architecture parameters: Parameters like the number of attention heads, the dimensionality of the embeddings, and the number of transformer blocks can also be tuned. However, in practice, these are often left at their default values as defined by the pretrained model, as changing them would require retraining the model from scratch.

Fine-tuning parameters: When fine-tuning a large language model on a specific task, the learning rate, batch size, and number of training steps can all be tuned to get the best performance on that task.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of one or more processors on a quantum computer, computing system, and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “large language model” may include, and is contemplated to include, a plurality of large language models. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### EXAMPLES

Example 1. A computer-implemented method to train or guide a machine learning model to generate a contract proposal document, the method comprising: receiving a request to generate a contract proposal, the request including a plurality of requirements and at least one of: an industry indication and a service indication; identifying, based on a first natural language model, a plurality of contract documents that satisfy at least one of the plurality of requirements; training, based on the first natural language model, the machine learning model to parse textual data in the identified plurality of contract documents; training, based on a second natural language model, the machine learning model to use the parsed textual data to generate input for the contract proposal document, wherein the generated input includes text that mimics semantics of the textual data to adhere to the plurality of requirements; and generating the contract proposal document using the generated input according to the training based on the first natural language model and the training based on the second natural learning model.

Example 2. The computer-implemented method of any one of the preceding examples, but particularly Example 1, wherein: the first natural language model is a first large language model; and the second natural language model is a second large language model.

Example 3. The computer-implemented method of any one of the preceding examples, but particularly Example 1, wherein mimicking the semantics of the textual data comprises: determining semantics and tone associated with work product generated by a selected user type; and generating the text for insertion into the contract proposal document according to the semantics and tone associated with the work product.

Example 4. The computer-implemented method of any one of the preceding examples, but particularly Example 3, wherein the selected user type comprises an export proposal writer, a novice proposal writer, or an engineer.

Example 5. The computer-implemented method of any one of the preceding examples, but particularly Example 1, wherein, in response to determining that one or more of the plurality of requirements is unsatisfied, updating the generated contract proposal document to include additional input to satisfy each unsatisfied requirement in the plurality of requirements.

Example 6. The computer-implemented method of any one of the preceding examples, but particularly Example 1, wherein the training based on the first natural language model comprises: performing unsupervised learning to select at least one contract document from the identified plurality of contract documents by comparing at least one field of the identified plurality of contract documents to match the industry indication or the service indication associated with the request; and performing supervised learning to parse the plurality of contract documents that meet at least one of the plurality of requirements and modify at least one model parameter to achieve a predefined predictive capability; and iterating the training based on the first natural language model upon determining that additional contract documents are available to parse.

Example 7. The computer-implemented method of any one of the preceding examples, but particularly Example 1, wherein the training based on the second natural language model comprises: performing unsupervised learning to select at least one contract document from the identified plurality of contract documents by comparing at least one field of the identified plurality of contract documents to match the industry indication or the service indication associated with the request; performing supervised learning to parse the plurality of contract documents that meet at least one of the plurality of requirements and modify at least one model parameter to achieve a predefined predictive capability; and performing reinforcement learning to generate additional textual content to be included in the contract proposal document.

Example 8. A computer-implemented method for predicting a probability of winning contract work, the method comprising: obtaining information comprising a plurality of identifiers, a plurality of contract documents, a plurality of available contract work, and historical data about awarded contracts; determining a likelihood, based on the obtained information and for each of the plurality of identifiers, of winning the respective contract work according to the plurality of contract documents and the historical data about awarded contracts, the determining comprising; ranking the determined likelihoods of winning the respective contract work; generating, based on the ranking, at least one bid and a contract proposal document for contract work having a ranking above a predefined level.

Example 9. A computer-implemented method of prioritizing contracts, the method comprising: training a first LLM model using existing contracts associated with a single or multiple companies; applying unsupervised learning to orient the first LLM toward government contracts; applying supervised learning from the previous contracts to tune the first LLM to increase predictive potential of the first LLM; tuning the first LLM to read and interpret government based contracts; adjusting one or more settings or parameters of the first LLM to increase a predictive capability of the first LLM; training a second LLM using available contracts associated with the single or multiple companies; applying unsupervised learning to orient the second LLM toward the government based contracts; applying supervised learning from the previous contracts to tune the second LLM to increase a predictive potential of the second LLM; tuning the second LLM to read and interpret the available contracts; adjusting one or more settings or parameters of the second LLM to increase a predictive capability of the second LLM; and applying reinforcement learning on the first LLM to cause the first LLM to output specific answers that mimic an expert proposal writer; and generating a new contract proposal document and inserting the specific answers into the contract proposal document.

Example 10. The computer-implemented method of any one of the preceding examples, but particularly Example 9, further comprising: applying reinforcement learning on the second LLM to increase a tone that mimic an expert proposal writer or that mimic another selectable user type.

What is claimed is:

1. A computer-implemented method to train or guide a machine learning model to generate a contract proposal document, the method comprising:
receiving a request to generate a contract proposal, the request including a plurality of requirements and at least one of: an industry indication and a service indication;
identifying, based on a first natural language model, a plurality of contract documents that satisfy at least one of the plurality of requirements;
training, based on the first natural language model, the machine learning model to parse textual data in the identified plurality of contract documents;
training, based on a second natural language model, the machine learning model to use the parsed textual data to generate input for the contract proposal document, wherein the generated input includes text that mimics semantics of the textual data to adhere to the plurality of requirements; and
generating the contract proposal document using the generated input according to the training based on the first natural language model and the training based on the second natural learning model.

2. The computer-implemented method of claim 1, wherein:
the first natural language model is a first large language model; and
the second natural language model is a second large language model.

3. The computer-implemented method of claim 1, wherein mimicking the semantics of the textual data comprises:
determining a semantics and a tone associated with work product generated by a selected user type; and
generating the text for insertion into the contract proposal document according to the semantics and the tone associated with the work product.

4. The computer-implemented method of claim 3, wherein the selected user type comprises an export proposal writer, a novice proposal writer, or an engineer.

5. The computer-implemented method of claim 1, wherein, in response to determining that one or more of the plurality of requirements is unsatisfied, updating the generated contract proposal document to include additional input to satisfy each unsatisfied requirement in the plurality of requirements.

6. The computer-implemented method of claim 1, wherein the training based on the first natural language model comprises:
performing unsupervised learning to select at least one contract document from the identified plurality of contract documents by comparing at least one field of the identified plurality of contract documents to match the industry indication or the service indication associated with the request; and
performing supervised learning to parse the plurality of contract documents that meet at least one of the plurality of requirements and modify at least one model parameter to achieve a predefined predictive capability; and
iterating the training based on the first natural language model upon determining that additional contract documents are available to parse.

7. The computer-implemented method of claim 1, wherein the training based on the second natural language model comprises:
performing unsupervised learning to select at least one contract document from the identified plurality of contract documents by comparing at least one field of the identified plurality of contract documents to match the industry indication or the service indication associated with the request;
performing supervised learning to parse the plurality of contract documents that meet at least one of the plurality of requirements and modify at least one model parameter to achieve a predefined predictive capability; and
performing reinforcement learning to generate additional textual content to be included in the contract proposal document.

8. A computer-implemented method for predicting a probability of winning contract work, the method comprising:
obtaining information comprising a plurality of identifiers, a plurality of contract documents, a plurality of available contract work, and historical data about awarded contracts;
determining a likelihood, based on the obtained information and for each of the plurality of identifiers, of winning the respective contract work according to the plurality of contract documents and the historical data about awarded contracts, the determining comprising;
ranking the determined likelihoods of winning the respective contract work; and
generating, based on the ranking, at least one bid and a contract proposal document for contract work having a ranking above a predefined level.

9. A computer-implemented method of prioritizing contracts, the method comprising:
training a first LLM model using existing contracts associated with a single or multiple companies;
applying unsupervised learning to orient the first LLM toward government contracts;
applying supervised learning from previous contracts to tune the first LLM to increase predictive potential of the first LLM;
tuning the first LLM to read and interpret government based contracts;
adjusting one or more settings or parameters of the first LLM to increase a predictive capability of the first LLM;
training a second LLM using available contracts associated with the single or multiple companies;
applying unsupervised learning to orient the second LLM toward the government based contracts;
applying supervised learning from the previous contracts to tune the second LLM to increase a predictive potential of the second LLM;
tuning the second LLM to read and interpret the available contracts;
adjusting one or more settings or parameters of the second LLM to increase a predictive capability of the second LLM; and
applying reinforcement learning on the first LLM to cause the first LLM to output specific answers that mimic an expert proposal writer; and
generating a new contract proposal document and inserting the specific answers into the contract proposal document.

10. The computer-implemented method of claim 9, further comprising:
applying reinforcement learning on the second LLM to increase a tone that mimic an expert proposal writer or that mimic another selectable user type.
